(19) United States
(12) Patent Application Publication
(10) Pub. No.: US 2007/0201958 A1
(43) Pub. Date: Aug. 30, 2007

(54) Cutter blade

(75) Inventor: Andrianus Gerardus van Houten, Schalkwijk (NL)

Correspondence Address: HOFFMANN & BARON, LLP, 6900 JERICHO TURNPIKE, SYOSSET, NY, 11791, US

(73) Assignee: Blastrac B.V.

(21) Appl. No.: 11/701,093

(22) Filed: Feb. 1, 2007

(30) Foreign Application Priority Data
Feb. 8, 2006 (EP) 06075279.7
Apr. 25, 2006 (EP) 06075952.9

(51) Int. Cl. B26D 1/12

(52) U.S. Cl. 407/53

(57) ABSTRACT

The invention provides a cutter blade (4) adapted to be arranged in a milling drum (1) of a milling machine. The cutter blade (4) has an annular body (7), and peripheral teeth (8) arranged at the annular body (7). The teeth (8) have a tooth face (9) and a clearance face (10) which intersect at a cutting edge (11). The teeth (8) are alternately arranged such that the tooth face (9) of one tooth (8a) is oriented in one tangential direction and the tooth face (9) of a neighbouring tooth (8b) is oriented in an opposite tangential direction. Thus a more versatile cutter blade is provided.

### CROSS-REFERENCE TO RELATED APPLICATIONS

This applications claims the benefit of European Application Nos. EP 06075279.7, filed Feb. 8, 2006 and EP 06077592.9, filed Apr. 25, 2006, the contents of which are incorporated herein by reference.

### BACKGROUND OF THE INVENTION

The invention relates to a cutter blade adapted to be arranged in a milling drum of a milling machine, the cutter blade having an annular body, and peripheral teeth arranged at the annular body, the teeth having a tooth face and a clearance face which intersect at a cutting edge.

In EP 1 300 226 A1 is in FIG. 3 shown a cutter blade for arrangement in a milling drum. The known cutter blade has peripheral teeth, which each have a tooth face and a clearance face which intersect at the cutting edge. All tooth faces of the known cutter blade are directed in one direction.

In JP 8284392 is shown an example of a rotary milling machine with a milling drum. The milling drum typically comprises a rotary shaft and a plurality of carrying rods that are arranged at the periphery of the drum and are extending parallel to the shaft. The cutter blades are arranged freely rotatable on the carrying rods. Upon rotation of the drum the cutter blades engage with their teeth the surface to be treated.

### SUMMARY OF THE INVENTION

The invention has for an object to provide a more versatile cutter blade.

This object is achieved by a cutter blade adapted to be arranged in a milling drum of a milling machine. The cutter blade has an annular body, and peripheral teeth arranged at the annular body. The peripheral teeth have a tooth face and a clearance face which intersect at a cutting edge. The teeth are alternately arranged such that the tooth face of one tooth is oriented in one tangential direction and the tooth face of a neighbouring tooth is oriented in an opposite tangential direction.

Use of a milling drum with cutting blades according to the invention can advantageously be used to remove flexible layers or harder coatings from e.g. concrete surfaces and provides a better and relatively smooth milling result, due to the two-way cutting action possibility of the cutter blades.

Preferably the tooth faces of the teeth are extending perpendicular with respect to the centre axis of the annular body.

Also, preferably the tooth face of each tooth lies in an imaginary plane which extends radially through the centre axis of the annular body.

Preferably the teeth are arranged in pairs, which teeth of such a pair are oriented to each other with respective rear faces, wherein the teeth of a pair preferably are separated by a groove, which is preferably V-shaped.

In a preferred embodiment the teeth of which the tooth faces are oriented towards each other are separated by a flute with a rounded bottom.

The ratio between the outer diameter of the blade and the thickness of the blade is preferably about 3.

The ratio between the outer diameter and the tooth height is preferably within the range of from 10 to 12.

In a preferred embodiment the blade has seven tooth pairs combined with an outer diameter of the blade within the range of from 45 mm to 50 mm.

The cutter blade may be made from hardmetal, preferably Tungsten Carbide.

Another aspect of the invention relates to a milling drum having two side plates which are interconnected by carrying rods, said carrying rods carrying cutter blades having an annular body arranged over the carrying rods in a freely rotatable manner, said cutter blades furthermore having peripheral teeth arranged at the periphery of the annular body, said peripheral teeth having a tooth face and a clearance face which intersect at a cutting edge, said peripheral teeth being alternately arranged such that the tooth face of one tooth is oriented in one tangential direction and the tooth face of a neighbouring tooth is oriented in an opposite tangential direction.

### BRIEF DESCRIPTION OF THE DRAWING

The invention will be described in more detail in the following description with reference to the accompanying drawing, in which:

FIG. 1 shows a perspective view of a preferred embodiment of a cutter blade according to the invention,

FIG. 2 shows a side elevational view of the cutter blade of FIG. 1,

FIG. 3 shows a top elevational view of the cutter blade according to FIG. 1, and

FIG. 4 shows a top elevational view of a milling drum of a milling machine.

### DETAILED DESCRIPTION OF THE INVENTION

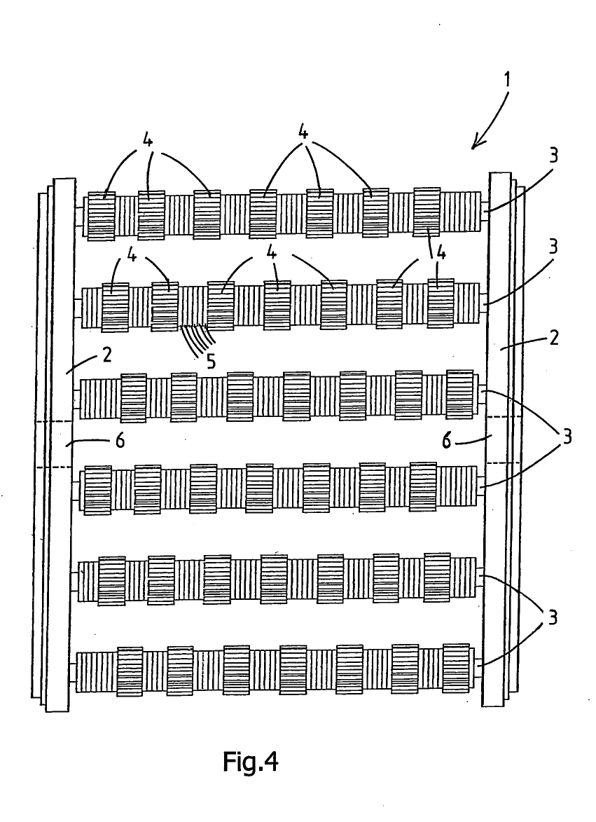

In FIG. 4 is shown a milling drum 1 of a milling machine. The milling drum 1 has two side plates 2 with a circular disc shape. The side plates 2 of the drum 1 are interconnected by carrying rods 3. On the carrying rods 3 are arranged cutter blades 4, such that the cutter blades 4 are freely rotatable with respect to the carrying rods 3. Also on the carrying rods 3, between the cutter blades 4, are arranged spacer rings 5. The side plates 2 are provided with a central opening 6 through which a rotational driving shaft (not shown) can be inserted, which shaft is designed to bring the drum in a rotational movement and can have round or polygonal cross sectional shape. The driving shaft can be driven by a motor via a gear, a belt or another transmission means.

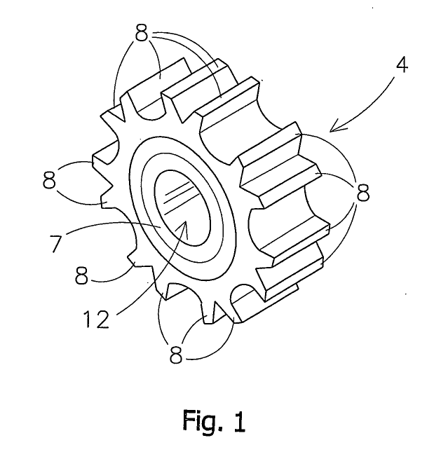

In FIGS. 1-3 the cutter blade 4 is illustrated in more detail.

The cutter blade 4 has an annular body 7 with a centre hole 12 through which in a mounted state of the cutter blade 4 the carrying rod 3 passes. On the annular body 7 are arranged peripheral teeth 8. The teeth 8 have a tooth face 9 and a clearance face 10 which intersect at a cutting edge 11. Furthermore the teeth 8 have a rear face 13. The teeth 8 have a tooth height h, which is the distance between the cutting edge 11 and the foot of the tooth 8. The clearance face has a clearance angle α.

The cutter blade is preferably entirely made from hardmetal, more preferably from Tungsten Carbide. It would also be possible to make only the teeth from hard metal and the annular body from a less hard material, although this would complicate the fabrication of the cutter blade.

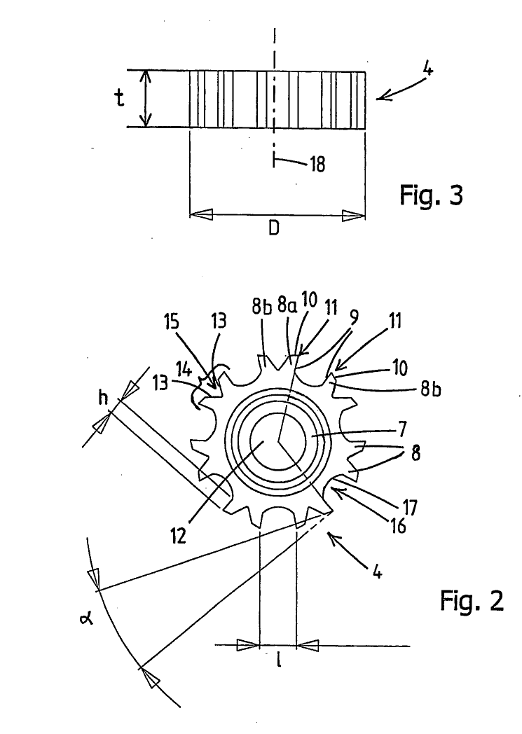

The teeth 8 are arranged in an alternate fashion such that the tooth face 9 of one tooth 8a is oriented in one tangential direction and the tooth face 9 of a neighbouring tooth 8b is oriented in an opposite tangential direction (see FIG. 2). The differently oriented teeth 8a and 8b can have a different shape, e.g. a different clearance angle α.

In the preferred embodiment shown in FIGS. 1-3 the tooth faces 9 of the teeth 8 extend perpendicular with respect to the centre axis 18 of the annular body 11, and preferably the tooth face 9 of each tooth 8 lies in a imaginary plane which extends radially through the centre axis 18 of the annular body 7 (cf. FIG. 2).

In the preferred embodiment shown in FIGS. 1-3 the teeth 8 are arranged in pairs. In FIG. 2 a pair is indicated by reference numeral 14. The teeth 8a, 8b of a single pair 14 are separated by a V-shaped groove 15 and the walls of the groove 15 are constituting the respective rear faces 13 of the teeth 8a, 8b.

The teeth 8 of which the tooth faces 9 are oriented towards each other are separated by a flute 16 with a slightly concavely rounded bottom surface 17.

To give an indication of the dimensions of a practically usable cutter blade by way of non limiting example: The cutter blade 4 may have an outer diameter D of for example between 45 and 50 mm, preferably 47 mm. The ratio between the outer diameter D of the blade and the thickness t of the blade may be about 3 and the thickness t can be for example 15 mm. The tooth height h is for example around 4 mm. The tangential distance l between two cutting edges 11 of two facing teeth 8 is around 10 mm. The clearance angle α can be 15° for the teeth 8a oriented in one tangential direction and 20° for the teeth 8b oriented in the other tangential direction. The cutter blade 4 of the example has seven tooth pairs combined with the outer diameter D of 47 mm.

The cutter blade 4 according to the invention is able to cut in two directions. If all teeth on the cutter blade are exactly the same this would mean that it does not matter in what direction the milling drum 1 is rotated. If the teeth 8a are differently shaped from the teeth 8b a different milling effect can be achieved by reversing the rotation direction of the milling drum 1.

It is to be understood that the given dimensions are for indicative purposes only. The cutter blade may well have other dimensions, as long as the mutual proportions are such that the cutter blade can remain to perform its function.

What is claimed is:

1. A Cutter blade adapted to be arranged in a milling drum of a milling machine, the cutter blade having an annular body, and peripheral teeth arranged at the annular body, the peripheral teeth having a tooth face and a clearance face which intersect at a cutting edge, wherein the teeth are alternately arranged such that the tooth face of one tooth is oriented in one tangential direction and the tooth face of a neighbouring tooth is oriented in an opposite tangential direction.

2. The cutter blade according to claim 1, wherein the tooth faces of the teeth are extending perpendicular with respect to the centre axis of the annular body.

3. The cutter blade according to claim 1, wherein the tooth face of each tooth lies in a imaginary plane which extends radially through the centre axis of the annular body.

4. The cutter blade according to claim 1, wherein the teeth are arranged in pairs, which teeth of such a pair are oriented to each other with respective rear faces.

5. The cutter blade according to claim 4, wherein the teeth of a pair are separated by a groove.

6. The cutter blade according to claim 5, wherein the groove is V-shaped.

7. The cutter blade according to claim 1, wherein the teeth of which the tooth faces are oriented towards each other are separated by a flute with a rounded bottom.

8. The cutter blade according to claim 1, wherein the ratio between the outer diameter of the blade and the thickness of the blade is about 3.

9. The cutter blade according to claim 1, wherein the ratio between the outer diameter and the tooth height is within the range of from 10 to 12.

10. The cutter blade according to claim 1, wherein the blade has seven tooth pairs combined with an outer diameter of the blade within the range of from 45 mm to 50 mm.

11. The cutter blade according to claim 1, wherein the cutter blade is made from hardmetal, preferably Tungsten Carbide.

12. A milling drum having two side plates which are interconnected by carrying rods, said carrying rods carrying cutter blades having an annular body arranged over the carrying rods in a freely rotatable manner, said cutter blades furthermore having peripheral teeth arranged at the periphery of the annular body, said peripheral teeth having a tooth face and a clearance face which intersect at a cutting edge, said peripheral teeth being alternately arranged such that the tooth face of one tooth is oriented in one tangential direction and the tooth face of a neighbouring tooth is oriented in an opposite tangential direction.
